(19) United States
(12) Patent Application Publication
(10) Pub. No.: US 2024/0177160 A1
(43) Pub. Date: May 30, 2024

(54) Collusion-Based Fraudulent Activity Identification System

(71) Applicant: Bank of America Corporation, Charlotte, NC (US)

(72) Inventors: Pranav Kaul, Gurugram (IN); Jasmeet Kaur Bhogal, Faridabad (IN); Prashant Khare, Maharashtra (IN); Neha Trehan, Uttar Pradesh (IN)

(21) Appl. No.: 18/059,584

(22) Filed: Nov. 29, 2022

(51) Int. Cl. G06Q 20/40; G06N 3/04; G06N 10/00; G06Q 50/00

(52) U.S. Cl. CPC G06Q 20/4016; G06N 3/04; G06N 10/00; G06Q 50/01; G06Q 2220/00

(57) ABSTRACT

A scalable influence concentration community detection apparatus comprising an optical quantum computing device capable of nomogram analysis to provide detection of a fraudster community. A consent mechanism for sourcing consent & data from social media websites may be implemented through oscillation cryptography. Community detection may be used to determine influence concentration for each customer of the organization's customer base through the data collated by a central organization, various financial institutions, and/or social media websites. An optical quantum computing based nomogram is used to detect a community profile for relationships between users. A consent method to source data from social websites may leverage photonic waves superimposition with another security mechanism.

### BACKGROUND

Bank fraud is a federal crime that involves fraudulent attempts for monetary gains by deceiving financial institutions. The most common types of bank fraud include debit and credit card fraud, account fraud, monetary concealment and/or movement obfuscation fraud, checking and saving accounts related fraud, homes loan fraud, auto loan fraud, payment fraud, deposit fraud, insurance fraud, and/or the like. Though financial institutions have multiple strategies, systems and filters to guard against such fraudulent activities, these strategies, systems, and filters may be circumvented by evolving dodging techniques performed by the fraudsters.

Fraud determination is the process of assessing accounts for risk and then addressing any risks that have been identified. An analyst may complete a detailed review of risk factors to determine the likelihood of fraud and may remediate any identified potential fraud activities accordingly. These risk factors are determined basis the repository maintained by the bank. Such identified potential fraud risks may be commonly referred to as “hot files”. These hot files and/or negative files are files containing one or more attributes identified as being potential fraud identifiers, such as a phone number, an address, an email address, an authorized username, and the like. These files may be created during fraud validations. Currently, systems haves no consolidated data available that may be used to identify the fraudster from other financial affiliated organizations (e.g., banks, brokers, and the like). As such, these risks expose the financial organization to greater threats that have a potential large negative impact on the organization's loss line. Further, the risks may enable a fraudster to make reentry attempts through different products and/or services. Further, successful and/or repeat fraudster activity leads to negative customer experience, particularly when the customer or an individual close to a customer are a victim of a scam or other fraudulent activity (e.g., identity theft, account takeover, or the like). Further, a lack of a common repository may lead to security threats with respect to customer information, customer assets, and/or financial institution assets.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary presents some concepts of the disclosure in a simplified form as a prelude to the description below.

Aspects of the disclosure relate to computer systems that provide effective, efficient, scalable, and convenient ways of securely and uniformly managing how internal computer systems exchange information with external computer systems to provide and/or support different products and services offered by an organization (e.g., a financial institution, and the like).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes identification of groups of malicious actors based on analysis of pooled relationship information.

Aspects of the disclosure provide solutions that address and overcome technical problems associated with intelligently and quickly identifying potential fraudulent activity at a financial institution. In particular, one or more aspects of the disclosure relate to creating an intelligent detection system, based on pooled customer data, to identify instances of potential collusion.

In some cases, the systems and methods may provide a scalable influence concentration community detection apparatus that may include an optical quantum computing based device capable of nomogram analysis to provide detection of a fraudster community. A consent mechanism for sourcing consent & data from Social media websites may be implemented through oscillation cryptography. In some cases, a method of community detection may be implemented via a computing device configured to determine influence concentration for each customer of the organization's customer base through the data collated by a central organization (e.g., a government organization, a commercial organization, a financial clearinghouse, and the like), various financial institutions, and/or social media websites. An optical quantum computing based Nomogram may be generated and/or leveraged to detect a community profile, including a fraudster community, a customer community, and/or the like. Further, a unique consent method to source data from social websites may leverage photonic waves superimposition with another security mechanism (e.g., an encrypted passcode, and/or the like). Further, the system may provide an unconventional method to detect fraudster communities and/or collusion behavior based on analysis of customer behavior. This identification may be gained through use of optimal clustering via photonic quantum computation. Further, a consent mechanism for sourcing consent to use and obtain data from one or more social media websites may utilize oscillation cryptography.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1A shows an illustrative computing environment for collusion-based fraudulent activity identification, in accordance with one or more aspects described herein;

FIG. 1B shows an illustrative computing platform enabled for collusion-based fraudulent activity identification, in accordance with one or more aspects described herein;

FIG. 2 shows an illustrative computing environment for identifying fraudster communities based on data pooled from a plurality of different organizations, in accordance with one or more aspects described herein;

FIG. 3 shows an illustrative computing platform enabled for scalable influence concentration community detection, in accordance with one or more aspects described herein;

FIG. 4 shows illustrative method of identifying an influence concentration nomogram, according to aspects of this disclosure;

FIG. 5 shows an illustrative optical quantum computing based Nomogram for community detection according to aspects of this disclosure; and

FIG. 6 shows an illustrative consent mechanism for sourcing data from social media websites using Oscillation Cryptography, according to aspects of this disclosure.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As used throughout this disclosure, computer-executable “software and data” can include one or more: algorithms, applications, application program interfaces (APIs), attachments, big data, daemons, emails, encryptions, databases, datasets, drivers, data structures, file systems or distributed file systems, firmware, graphical user interfaces, images, instructions, machine learning (e.g., supervised, semi-supervised, reinforcement, and unsupervised), middleware, modules, objects, operating systems, processes, protocols, programs, scripts, tools, and utilities. The computer-executable software and data is on tangible, computer-readable memory (local, in network-attached storage, or remote), can be stored in volatile or non-volatile memory, and can operate autonomously, on-demand, on a schedule, and/or spontaneously.

“Computer machines” can include one or more: general-purpose or special-purpose network-accessible administrative computers, clusters, computing devices, computing platforms, desktop computers, distributed systems, enterprise computers, laptop or notebook computers, primary node computers, nodes, personal computers, portable electronic devices, servers, node computers, smart devices, tablets, and/or workstations, which have one or more microprocessors or executors for executing or accessing the computer-executable software and data. References to computer machines and names of devices within this definition are used interchangeably in this specification and are not considered limiting or exclusive to only a specific type of device. Instead, references in this disclosure to computer machines and the like are to be interpreted broadly as understood by skilled artisans. Further, as used in this specification, computer machines also include all hardware and components typically contained therein such as, for example, processors, executors, cores, volatile and non-volatile memories, communication interfaces, etc.

Computer “networks” can include one or more local area networks (LANs), wide area networks (WANs), the Internet, wireless networks, digital subscriber line (DSL) networks, frame relay networks, asynchronous transfer mode (ATM) networks, virtual private networks (VPN), or any combination of the same. Networks also include associated “network equipment” such as access points, ethernet adaptors (physical and wireless), firewalls, hubs, modems, routers, and/or switches located inside the network and/or on its periphery, and software executing on the foregoing.

The above-described examples and arrangements are merely some examples of arrangements in which the systems described herein may be used. Various other arrangements employing aspects described herein may be used without departing from the innovative concepts described.

The systems and methods of this disclosure describe a scalable influence concentration community detection device capable of identifying groups of malicious actors based on an analysis of transaction information and social media posts, such as by generating an optical quantum computing based nomogram for community detection and where a consent mechanism for sourcing consent & data from one or more social media websites may involve use of oscillation cryptography.

The system and methods may use pooled data, such as data from a government organization and/or one or more financial institutions. For example, the pooled data may be stored as a cloud-based data lake and may be protected via one or more institutional authentication system. This system may be used to monitor and/or analyze transactions corresponding to a plurality of financial products, such as credit cards, debit cards, open accounts, account opening activities, loan products, mortgage products, checking transactions, online electronic transactions and the like. These transactions may be analyzed using one or more filters (e.g., fraud filters, algorithms, and the like), at the individual customer level. The system may apply a classification methodology to classify activities associated with individual users into one or more communities (e.g., a fraudster community, a watchlist community, a trusted user community, and the like). The community identification may be used to block manage transaction execution, such as by blocking a transaction, holding execution of the transaction, and/or clearing the transaction.

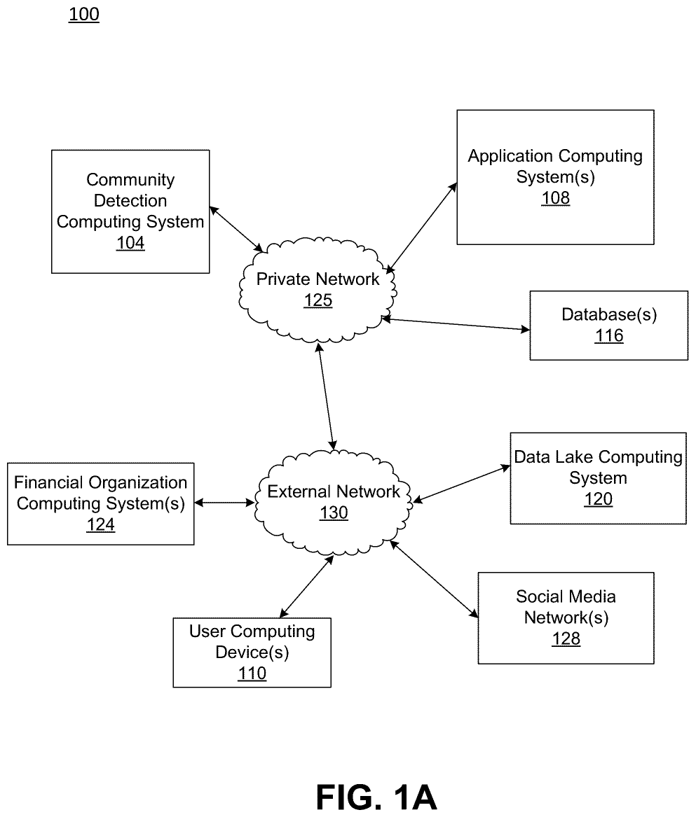

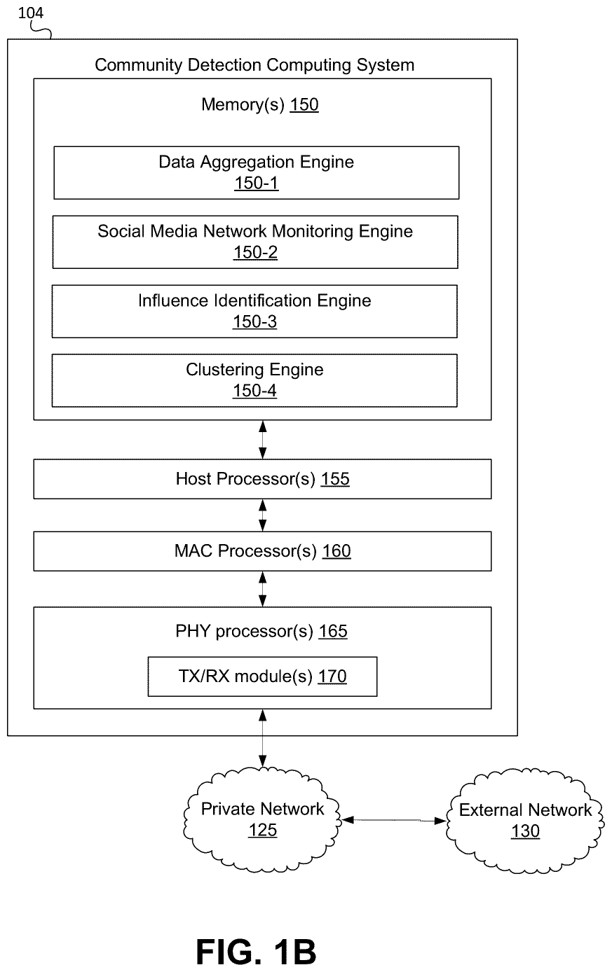

FIG. 1A shows an illustrative computing environment 100 for collusion-based fraudulent activity identification, in accordance with one or more arrangements. The computing environment 100 may comprise one or more devices (e.g., computer systems, communication devices, and the like). The computing environment 100 may comprise, for example, a community detection computing system 104, one or more application systems 108, and/or one or more database(s) 116. The one or more of the devices and/or systems, may be linked over a private network 125 associated with an enterprise organization (e.g., a financial institution, a business organization, an educational institution, a governmental organization and the like). The computing environment 100 may additionally comprise one or more financial organization computing systems 124, one or more social network 128, a data lake computing system 120 and one or more user devices 110 connected, via a public network 130, to the devices in the private network 125. The devices in the computing environment 100 may transmit/exchange/share information via hardware and/or software interfaces using one or more communication protocols. The communication protocols may be any wired communication protocol(s), wireless communication protocol(s), one or more protocols corresponding to one or more layers in the Open Systems Interconnection (OSI) model (e.g., local area network (LAN) protocol, an Institution of Electrical and Electronics Engineers (IEEE) 802.11 WIFI protocol, a 3^{rd} Generation Partnership Project (3GPP) cellular protocol, a hypertext transfer protocol (HTTP), etc.). While FIG. 1A shows the community detection computing system 104 as a separate computing system, one or more components of the community detection computing system may be incorporated within another computing system.

The community detection computing system 104 may comprise one or more computing devices and/or other computer components (e.g., processors, memories, communication interfaces) configured to perform one or more functions as described herein. Further details associated with the architecture of the community detection computing system 104 are described with reference to FIG. 1B.

The application computing systems 108 and/or a client system may comprise one or more computing devices and/or other computer components (e.g., processors, memories, communication interfaces). In addition, the application computing system 108 and/or the client system may be configured to host, execute, and/or otherwise provide one or more enterprise applications. In some cases, the application computing systems 108 may host one or more services configured facilitate operations requested through one or more API calls, such as data retrieval and/or initiating processing of specified functionality. In some cases, the client computing system may be configured to communicate with one or more of the application computing systems 108 such as via direct communications and/or API function calls and the services. In an arrangement where the private network 125 is associated with a financial institution (e.g., a bank), the application computing systems 108 may be configured, for example, to host, execute, and/or otherwise provide one or more transaction processing programs, such as an online banking application, fund transfer applications, and/or other programs associated with the financial institution. The client computing system and/or the application computing systems 108 may comprise various servers and/or databases that store and/or otherwise maintain account information, such as financial account information including account balances, transaction history, account owner information, and/or other information. In addition, the client computing system and/or the application computing systems 108 may process and/or otherwise execute transactions on specific accounts based on commands and/or other information received from other computer systems comprising the computing environment 100. In some cases, one or more of the client computing system and/or the application computing systems 108 may be configured, for example, to host, execute, and/or otherwise provide one or more transaction processing programs, such as electronic fund transfer applications, online loan processing applications, and/or other programs associated with the financial institution.

The application computing systems 108 may be one or more host devices (e.g., a workstation, a server, and the like) or mobile computing devices (e.g., smartphone, tablet). In addition, an application computing systems 108 may be linked to and/or operated by a specific enterprise user (who may, for example, be an employee or other affiliate of the enterprise organization) who may have administrative privileges to perform various operations within the private network 125. In some cases, the application computing systems 108 may be capable of performing one or more layers of user identification based on one or more different user verification technologies including, but not limited to, password protection, pass phrase identification, biometric identification, voice recognition, facial recognition and/or the like. In some cases, a first level of user identification may be used, for example, for logging into an application or a web server and a second level of user identification may be used to enable certain activities and/or activate certain access rights.

The data lake computing system 120, the financial organization computing systems 124, the social media networks 128 may comprise one or more computing devices and/or other computer components (e.g., processors, memories, communication interfaces). The financial organization computing systems 124 may include components that are configured, for example, to host, execute, and/or otherwise provide one or more transaction processing programs, such as goods ordering applications, electronic fund transfer applications, online loan processing applications, and/or other programs associated with providing a product or service to a user, similar to the application computing systems 108. For example, where a component of the financial organization computing systems 124 is for processing an electronic exchange of goods and/or services. The client computing system 120 may be associated with a specific goods purchasing activity, such as purchasing a vehicle, transferring title of real estate. In some cases, the financial organization computing systems 124 may include one or more components that may perform functionality and/or communicate with one or more other platforms within the financial organization computing systems 124. In some cases, the financial organization computing systems 124 may integrate API calls to request data, initiate functionality, or otherwise communicate with the one or more application systems, such as via the services. For example, the services may be configured to facilitate data communications (e.g., data gathering functions, data writing functions, and the like) between the components of the financial organization computing systems 124 and the one or more application systems.

The data lake computing system 120 may be a centrally located data repository, such as a big data repository, that stores information received from a plurality of enterprise organization computing systems such as the system 100 and/or one or more of the financial organization computing systems 124. In some cases, the data lake computing system 120 may be associated with a governmental or other regulatory organization. For example, the data lake computing system 120 may comprise a data repository (e.g., a big data-based data repository) storing financial transaction information received from a plurality of enterprise organizations. In an illustrative example, the data lake computing system 120 may be associated with an organization tasked with investigating and/or identifying potential instances of financial crimes. For example, the Financial Crime Enforcement Network (FinCEN) is a bureau of the U.S. Department of the Treasury. The mission of FinCEN is to safeguard the financial system from illicit use and/or combat monetary use obfuscation activities and promote national security through the collection, analysis, and dissemination of financial intelligence and strategic use of financial authorities. FinCEN carries out its mission by receiving and maintaining financial transactions data, such as those received from the system 100 (e.g., from the application computing systems 108) and/or from components of the financial organization computing systems 124. FinCEN may also provide functionality for analyzing and disseminating that data for law enforcement purposes, and/or building global cooperation with counterpart organizations in other countries and with international bodies. In some cases, the data collected by FinCEN may be leveraged by enterprise organizations (e.g., financial organizations, banking organizations, insurance providers, and/or other financial service organizations) to identify and/or predict an occurrence of financial crimes within their individual networks and identify patterns of activity and/or cooperation between individuals when performing financial crimes based on analysis of cross system and/or organizational information.

The user device(s) 110 may be computing devices (e.g., desktop computers, laptop computers) or mobile computing device (e.g., smartphones, tablets) connected to the network 125. The user device(s) 110 may be configured to enable the user to access the various functionalities provided by the devices, applications, and/or systems in the network 125.

As the global population progresses rapidly in getting online and media-enabled, corresponding volumes of “cross-connections” between data points managed by an enterprise (e.g., data received from Social media sources, professional media sources, organizational data repositories, and the like) will grow rapidly. The corresponding data graphs, including connected edges and vertices, grow super-exponentially as the number of data points increases. This data growth poses a huge problem for enterprises in providing efficient yet practical methods for managing risk, analyzing large amounts of data and forming predictions based on the large volumes of both enterprise generated data and external-sourced data. Often, this rapid growth makes data management intractable for analyzing data and forming predictions based on the analyzed data in regards to critical business functions. However, such data growth provides other opportunities, particularly when comparing information across organizations where patterns of activity (e.g., malicious activity, financial crimes, and the like) may be identified more easily.

Further, the community detection computing system 104 may acquire information related to the user, the user devices 170 associated with the user and/or access notification, and/or the user associated with the search request and/or access notification from one or more external sources. For example, the community detection computing system 104 may acquire information from various social media platforms and/or networks 128 (e.g., Facebook, Instagram, Twitter, Pinterest, LinkedIn, and the like). Additionally or alternatively, the community detection computing system 104 may retrieve results generated by various search systems (e.g., Google, Bing, and the like). In some cases, a sourcing engine server may retrieve information corresponding to users associated with one or more financial organizations and may identify one or more connections between individuals and/or other users of financial services provided by the application computing systems 108 and/or the financial organization computing systems 124, via the Internet from the various social media channels and/or devices discussed above.

Connections between individuals may be identified by one or more components of the community detection computing system via information observed on a plurality of social media networks, 128, the data lake computing system 120, and/or one or more internal systems and/or databases (e.g., the database 116 and the like). The community detection computing system 104 may include various components, modules, and sub-modules that facilitate various tasks, including identifying one or more users of an entity's products and/or services, identifying one or more individuals that also use the entity's products and services, and/or external individuals known and trusted by the user, sourcing information from one or more internal data stores, sourcing information from one or more external sources (e.g., social media networks 128, the data lake computing system 120, and the like), analyzing the information based on rules defined by the entity, identifying one or more connections between individuals (e.g., liking a social media post, reposting a social media post, and the like) and then grouping individuals based on a weighted combination of factors and/or other information to identify communities of individuals (e.g., trusted consumers, identified fraudsters, individuals on a watchlist, neutral parties, and the like). It will be appreciated that the community detection computing system 104 illustrated in FIGS. 1A and 1B are shown by way of example and that other implementations of the community detection computing system 104 may include additional or alternative components, modules, sub-modules, and the like. Thus, the community detection computing system 104 may be implemented using a special-purpose computing device (or computing devices) that have been specially programmed to perform functionality according to one or more aspects of the present disclosure.

The database(s) 116 may comprise one or more computer-readable memories storing information that may be used by the community detection computing system 104. For example, the database(s) 116 may store electronic transaction information, consent information, community relationship information, and the like. In an arrangement, the database(s) 116 may be used for other purposes as described herein. In some cases, the client computing system 120 may write data or read data to the database(s) 116 via the services.

In one or more arrangements, the community detection computing system 104, the application systems 108, the data lake computing system 120, the social media platforms or networks 128, the financial organization computing systems 124, the user devices 110, and/or the other devices/systems in the computing environment 100 may be any type of computing device capable of receiving input via a user interface, and communicating the received input to one or more other computing devices in the computing environment 100. For example, the community detection computing system 104, the application systems 108, the data lake computing system 120, the social media platforms or networks 128, the financial organization computing systems 124, the user devices 110, and/or the other devices/systems in the computing environment 100 may, in some instances, be and/or include server computers, desktop computers, laptop computers, tablet computers, smart phones, wearable devices, or the like that may comprised of one or more processors, memories, communication interfaces, storage devices, and/or other components. Any and/or all of the community detection computing system 104, the application systems 108, the data lake computing system 120, the social media platforms or networks 128, the financial organization computing systems 124, the user devices 110, and/or the other devices/systems in the computing environment 100 may, in some instances, be and/or comprise special-purpose computing devices configured to perform specific functions.

FIG. 1B shows an illustrative community detection computing system 104 in accordance with one or more examples described herein. The community detection computing system 104 may be a stand-alone device and/or may at least be partial integrated with the another computing system may comprise one or more of host processor(s) 155, medium access control (MAC) processor(s) 160, physical layer (PHY) processor(s) 165, transmit/receive (TX/RX) module(s) 170, memory 150, and/or the like. One or more data buses may interconnect host processor(s) 155, MAC processor(s) 160, PHY processor(s) 165, and/or Tx/Rx module(s) 170, and/or memory 150. The community detection computing system 104 may be implemented using one or more integrated circuits (ICs), software, or a combination thereof, configured to operate as discussed below. The host processor(s) 155, the MAC processor(s) 160, and the PHY processor(s) 165 may be implemented, at least partially, on a single IC or multiple ICs. The memory 150 may be any memory such as a random-access memory (RAM), a read-only memory (ROM), a flash memory, or any other electronically readable memory, or the like.

Messages transmitted from and received at devices in the computing environment 100 may be encoded in one or more MAC data units and/or PHY data units. The MAC processor(s) 160 and/or the PHY processor(s) 165 of the community detection computing system 104 may be configured to generate data units, and process received data units, that conform to any suitable wired and/or wireless communication protocol. For example, the MAC processor(s) 160 may be configured to implement MAC layer functions, and the PHY processor(s) 165 may be configured to implement PHY layer functions corresponding to the communication protocol. The MAC processor(s) 160 may, for example, generate MAC data units (e.g., MAC protocol data units (MPDUs)), and forward the MAC data units to the PHY processor(s) 165. The PHY processor(s) 165 may, for example, generate PHY data units (e.g., PHY protocol data units (PPDUs)) based on the MAC data units. The generated PHY data units may be transmitted via the TX/RX module(s) 170 over the private network 155. Similarly, the PHY processor(s) 165 may receive PHY data units from the TX/RX module(s) 165, extract MAC data units encapsulated within the PHY data units, and forward the extracted MAC data units to the MAC processor(s). The MAC processor(s) 160 may then process the MAC data units as forwarded by the PHY processor(s) 165.

One or more processors (e.g., the host processor(s) 155, the MAC processor(s) 160, the PHY processor(s) 165, and/or the like) of the community detection computing system 104 may be configured to execute machine readable instructions stored in memory 150. The memory 150 may comprise (i) one or more program modules/engines having instructions that when executed by the one or more processors cause the community detection computing system 104 to perform one or more functions described herein and/or (ii) one or more databases that may store and/or otherwise maintain information which may be used by the one or more program modules/engines and/or the one or more processors. The one or more program modules/engines and/or databases may be stored by and/or maintained in different memory units of the community detection computing system 104 and/or by different computing devices that may form and/or otherwise make up the community detection computing system 104. For example, the memory 150 may have, store, and/or comprise a data aggregation engine 150-1, a social media network monitoring engine 150-2, an influence identification engine 150-3, a clustering engine 150-4, and/or the like. The data aggregation engine 150-1 may have instructions that direct and/or cause the community detection computing system 104 to perform one or more operations associated with aggregating data from a plurality of data sources, such as by aggregating transaction information from a plurality of data stores and/or aggregating information from one or more data sources external to the enterprise network, and the like. The social media network monitoring engine 150-2 may have instructions that may cause the community detection computing system 104 to monitor activity associated with one or more parties to one or more transactions at the enterprise organization and/or the one or more external enterprise organizations (e.g., the external financial institution computing systems 124) and to aggregate data (e.g., posting information, reaction to post information, reposting information, friend information, contact information, and the like) associated with such individuals. The influence identification engine 150-2 may have instructions that may cause the community detection computing system 104 to process the social media information aggregated by the social media network monitoring engine 15-2 and/or the transaction information aggregated by the data aggregation engine 150-1 to identify relationships between individuals and/or identify an influence characteristic between activities performed by different individuals. The clustering engine 150-4 may have instructions that may cause the community detection computing system 104 to perform actions to cluster individuals into various communities, such as to identify a community of individuals that may be likely to participate in fraudulent or other malicious financial activities.

While FIG. 1A illustrates the community detection computing system 104 and the application systems 108, as being separate elements connected in the private network 125, in one or more other arrangements, functions of one or more of the above may be integrated in a single device/network of devices. For example, elements in the community detection computing system 104 (e.g., host processor(s) 155, memory(s) 150, MAC processor(s) 160, PHY processor(s) 165, TX/RX module(s) 170, and/or one or more program/modules stored in memory(s) 150) may share hardware and software elements with and corresponding to, for example, the application systems 108.

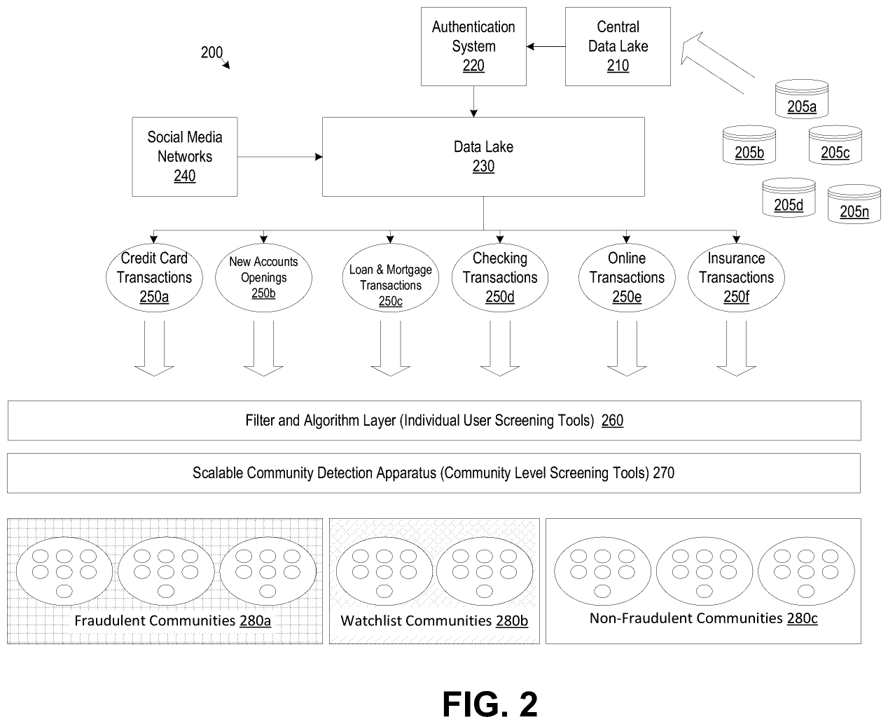

FIG. 2 shows an illustrative computing environment 200 for identifying fraudster communities based on data pooled from a plurality of different organizations. In some cases, the computing environment 200 may include a computing system that may be used to create an intelligent community detection system using customer data to identify for potential collusion activities to detect potential financial crimes. For example, the computing environment may include one or more financial institution computing systems that each may include data repositories storing transaction information (e.g., the data repositories 205a-205n). These data repositories may communicate financial information (e.g., transaction information) via a network to a central data repository (e.g., a central data lake 210). In some cases, the central data lake 210 may be a data repository associated with a governmental or regulatory organization (e.g., FinCEN) which may be used to identify, predict and/or prevent financial crime activity. The computing environment 200 may further include an authentication system 220 that may facilitate communication activities (e.g., data upload, data download, data synchronization, and the like) between financial organization data stores (e.g., the data repositories 205a-205n, a data lake 230, and the like) and the central data lake 210. In some cases, an enterprise organization's computing network may include the data lake 230, which may store user related information (e.g., customer transaction information, customer communications information, and the like). For example, the data lake 230 may store information corresponding to users that have executed or participated in at least one financial transaction with the enterprise organization. Such financial transactions may include credit card transactions, new account opening activities, loan and/or mortgage transactions, checking transactions, online transactions (e.g., money transfer activities, investment activities, and the like), insurance related transactions, and/or the like. For each user, the data lake 230 may further store customer relationship information, such as information corresponding to one or more social media posts. For example, the data lake may store information corresponding to an individual's activity on a plurality of social media websites, such as posting information, likes, reposts, tags, shares, cross-posts, and/or the like. Such information may be used to identify relationships between individuals that have at least one transaction with the enterprise network and/or have transacted with one or more additional financial institutions.

The computing environment 200 may further include one or more data repositories that store transaction information with one or more products and/or services provided by the enterprise organization via the enterprise network. Such products and/or services may be provided via the application computing systems 108, such as a credit card processing service (e.g., a credit card transaction data repository 250a), an account management and/or transaction service (e.g., an account data repository 250b), a loan or mortgage service (e.g., a loan or mortgage transaction data repository 250c), a checking service (e.g., a checking data repository 250d), an online transaction service (e.g., an online transaction data repository 250e), an insurance service (e.g., an insurance data repository 250f), and/or the like.

The computing environment 200 may further include one or more computing tools, modules and/or services implemented to analyze information in the data repositories discussed above to provide insight regarding relationships between individuals that transact with the products and/or services provided by the enterprise organization (e.g., a bank, a financial institution, and/or the like) and/or with one or other financial institutions. For example, the tools may include individual user screening tools (e.g., implemented as a filtering and/or algorithm processing layer 260), a community level screening tool (e.g., a scalable community detection apparatus or service 270) and/or the like, where information corresponding to different user communities may be identified, such as a community of trusted individuals (e.g., a non-fraudulent community 280c, a loyal customer community, a neutral customer community, and/or the like), a community of watch-listed individuals 280b comprising groupings of individuals that are under further examination, and/or a community of individuals that have been identified as participating, or likely to be participating in fraudulent or malicious activities (e.g., a fraudulent community 280b).

This system may use pooled data, such as data from a government organization and/or one or more financial institutions. For example, the pooled data may be stored as a cloud-based data lake and may be protected via one or more institutional authentication system. This system may be used to monitor and/or analyze transactions corresponding to a plurality of financial products, such as credit cards, debit cards, open accounts, account opening activities, loan products, mortgage products, checking transactions, online electronic transactions and the like. These transactions may be analyzed using one or more filters (e.g., fraud filters, algorithms, and the like), at the individual customer level. The system may apply a classification methodology to classify activities associated with individual users into one or more communities (e.g., a fraudster community, a watchlist community, a trusted user community, and the like). The community identification may be used to block manage transaction execution, such as by blocking a transaction, holding execution of the transaction, and/or clearing the transaction.

The system may include a scalable community detection apparatus that may apply different methodologies to classify customers into the communities (e.g., the previously identified fraudulent community, watchlist community, trusted community, non-fraudster community). Further, the influence concentration community detection apparatus may be scalable, so that the same methodology, device, or system may analyze community activities for users of an organization, within a particular region, among various organizations, or the like. To do so, the system may source data corresponding to previously identified fraudsters, including their identified associates and/or historical fraudulent activities across various organizations and/or regions. In some cases, the system may collect customer data from social media platforms to leverage that information to identify community connections between users (e.g., acquaintance, friend, colleague, follower, relative, and/or the like).

In some cases, data collected may be stored in a centralized data repository (e.g., a data lake) and from which data may be further utilized for calculating characteristics and/or predictive identifiers (e.g., a veracity index). The veracity index may be identified based on various characteristics of user interactions between different users over one or more different social networks, such as a number of likes, reposts, tags, shares, and the like. In some cases, an influence index of one or more social media platforms may be calculated via optical computing systems. Further, influence concentration indexes may be calculated and used to create an influence concentration nomogram through which the computing device may perform clustering of different individuals into communities, such as a fraudster community, a loyal customer community, a neutral user community, a watchlist user community, and the like. Such community clustering may be achieved by applying heuristics to score user characteristics and may be combined using optical quantum computing based on a size and/or scale of the available data and clustering of an extremely large user base (e.g., big data repository, millions of users, and the like). The optical quantum computing may further facilitate influence concentration nomogram generation and/or analysis considering the scale of the data scope.

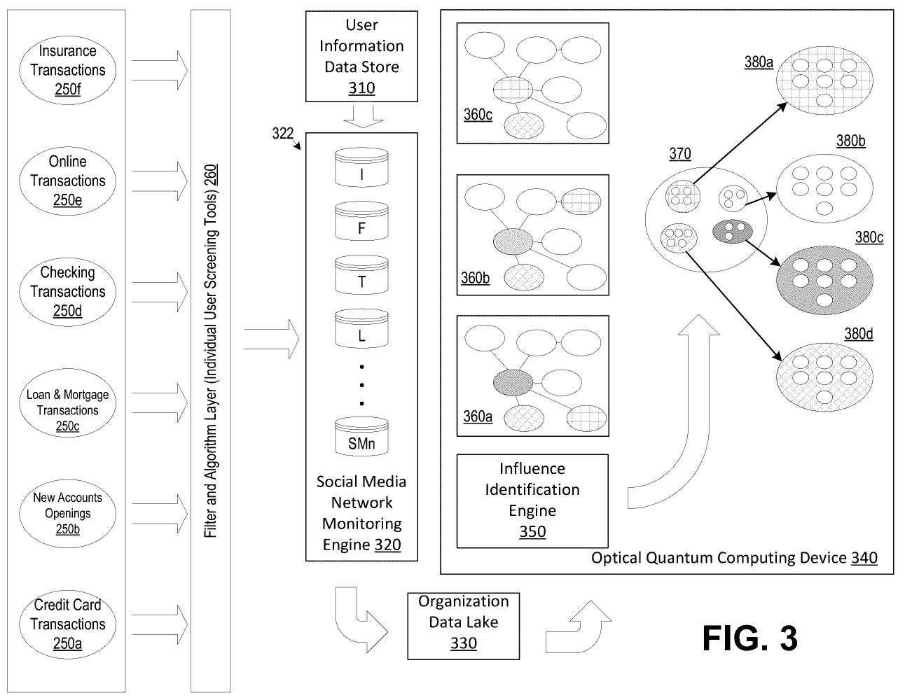

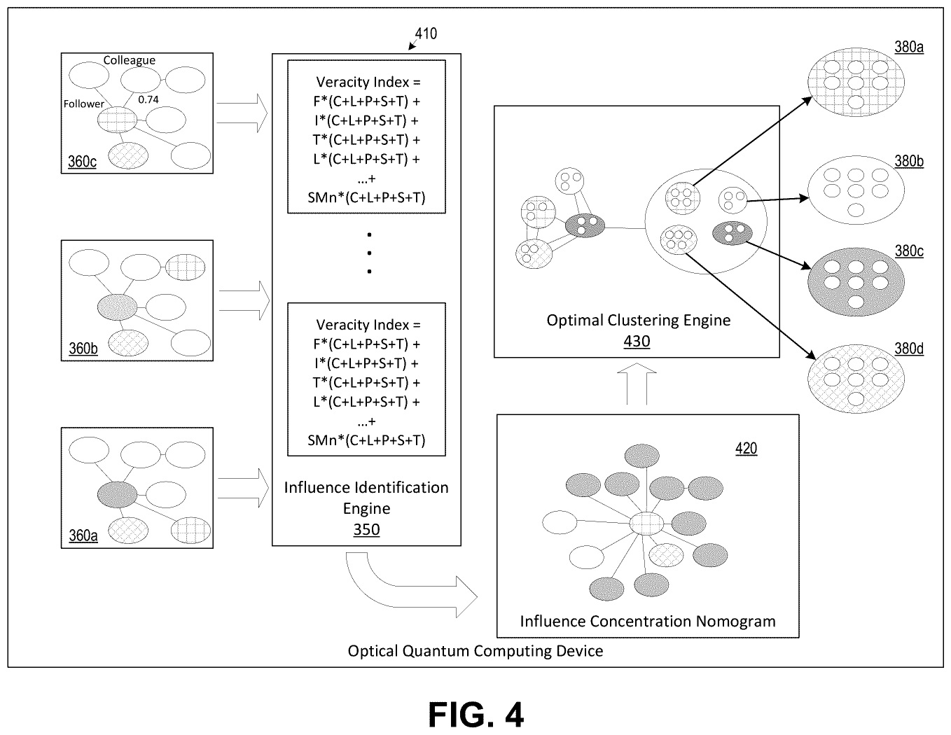

As mentioned, the optical quantum computing based nomogram may be used for community detection for large numbers of users, as shown in FIGS. 3 and 4. The system may create nomograms on smart systems (e.g., a smart holographic glass) through optical quantum computing using qubits to suitably cluster individuals into communities. In doing so, the optical quantum computing system may proactively determine communities of fraudsters based on information shared between enterprise organizations. FIG. 3 shows an illustrative computing platform enabled for scalable influence concentration community detection, in accordance with one or more aspects described herein. For example, the computing platform of FIG. 3 comprises a more detailed view of the system 200, where data from the transaction data repositories including one or more of the credit card transaction data repository 250a, the account data repository 250b, the a loan or mortgage transaction data repository 250c, the checking data repository 250d, the online transaction data repository 250e, and the insurance data repository 250f may be sampled and analyzed by the individual user screening tools 260 to identify users that are or have been interacting with the products and/or services (e.g., transaction activities) offered by the enterprise organization. Such information may further be provided as an input to a social media network monitoring engine 320, along with additional user information (e.g., contact information, peer level information, employment information, and the like) from a user information data store 310, where each of a plurality of social media networks 322 may be monitored based on the input information. The social media network monitoring engine may capture social media activities (e.g., posting, reposting, liking, sharing, and the like) being performed by these individuals. Further, the social media network monitoring engine may capture information corresponding to individuals that interact with (e.g., posting, reposting, liking, sharing, and the like) content provided by the individuals to build a connection web concerning the relationships between these individuals. This relationship information may be stored with, in some cases, at least a portion of the analyzed transaction information and/or social media network information within an organization data lake 330 that may be internal to the enterprise organization. In some cases, due to a volume of social media information and/or transaction information being analyzed, the organization data lake 330 may be a big data-enabled data repository or another data storage technology capable of storing huge amounts of information.

The data stored in the organization data lake 330 may be analyzed by an optical quantum computing device 340 programmed to provide influence identification nomograms and/or community relationships between individuals that have transacted with one or more financial institutions. In some cases, the optical quantum computing device 340 may further analyze similar information from one or more external sources, such as a governmental data lake (e.g., a FinCEN data repository), or more data lakes associated with another financial institution, and/or the like. An influence identification engine 350 may be implemented by the optical quantum computing device 340 and enabled to generate one or more influence nomograms 360a-360c, each being associated with a particular individual. For example, the nomogram 360a may be associated with a first individual, the nomogram 360b may be associated with a second individual, and the nomogram 360c may be associated with a third individual.

Each nomogram 360a-360b may show relationships between individuals as identified via the social media post analysis. Further, each individual represented within the nomogram 360a-360c may further be associated with an identifier associated with a level of trust assigned to that particular individual. For example, an individual may be classified as a loyal customer, a trusted user, a neutral party, an individual on a watch list, a fraudster, and/or the like. The optical quantum computing device 340 may further group these individuals into communities 370 based on relationship information identified by through the social media network analysis and transaction activity associated with the customer and/or transaction activity associated with each individual that interacts with the customer on one or more social media websites. Based on this information and analysis, the optical quantum computing device may generate a fraudster community 380a associated with an identified community of fraudsters that may cooperate together and/or may act individually to commit financial crimes or other malicious activities. Further groups may include a trusted community 380b, a neutral community 380c, and a watchlist community 380d. In some cases, additional monitoring of transaction activity may be enabled for individuals within the watchlist community 380d and the fraudster community 380a. For example, identified transactions for individuals within the watchlist community 380d and the fraudster community 380a may trigger an automatic analysis of aspects of the identified transactions, such as a source account, a target account, an amount, address information, party information, and the like. Further, if any aspect is identified as being suspect, the transaction may be automatically canceled, frozen or the like.

FIG. 4 shows illustrative method of identifying an influence concentration nomogram, according to aspects of this disclosure. Here, the optical quantum computing device may analyze connections between individuals represented by unique nomograms 360a-360c. These nomograms 360a-360c may be fed as inputs to the influence identification engine 350, where the individual's relationships may be analyzed and classified based on one or more formulas or algorithms. For example, a “veracity index” may be calculated for each individual and/or each relationship between individuals based on, for example, a weighted combination of interactions between individuals on each of a plurality of social media networks. For example, the veracity index may be a scaled and/or weighted combination of factors multiplied by a value associated with a social network. The value associated with the social network may further be related to a number of times the individual is active on the social media platform within a given time frame, an amount of active time the individual is active on the social media network, a level of interaction via posts on the social media network between individuals, and the like. A sample equation may be: Veracity Index=F*(C+L+P+S+T)+I*(C+L+P+S+T)+T*(C+L+P+S+T)+L*(C+L+P+S+T)+ . . . +SMn*(C+L+P+S+T), where F, I, T, L, . . . , SMn correspond to a weighting factor assigned to each individual social media platform, and C=a number of cross posts, L=a number of likes, P=a number of posts, S=a number of shares, T=a number of tags.

In some cases, the veracity index between individuals may be used to gauge a strength of a relationship between individuals. In some cases, a strong relationship between a user and a known fraudster may increase a value of the social media network constant. In some cases, a value of the veracity index may be compared to at least one threshold to identify whether a criterion has been met for a particular community membership. In some cases, a threshold value may be set for a membership quantifier for each community. For example, individuals having a veracity index≤0.2 may be trusted, individuals having a 0.2<veracity index≤0.4 may be loyal, individuals having a 0.4<veracity index≤0.6 may be neutral, individuals having a 0.6<veracity index≤0.8 may be on a watchlist, and individuals having veracity index>0.8 may be within the fraudster community.

Additionally, the influence identification engine 350 may use this information and the veracity index calculation for each individual to generate an influence concentration Nomogram 420 associated with each user's interaction with others over all the monitored social media networks. Because this analysis is extremely data intensive (e.g., hundreds of millions of users, thousands of connections for each user, and the like), silicon-based computing devices do not have the capacity to perform these calculations and generate the nomograms within a reasonable time (e.g., under 1 minute). As such optical quantum computing devices are programmed to perform these calculations. Additionally, the influence concentration nomograms are further analyzed by an optimal clustering engine 430 to cluster individuals into corresponding communities based on an identified connection and a strength of each connection between all individuals, as learned via the social media post monitoring and analysis.

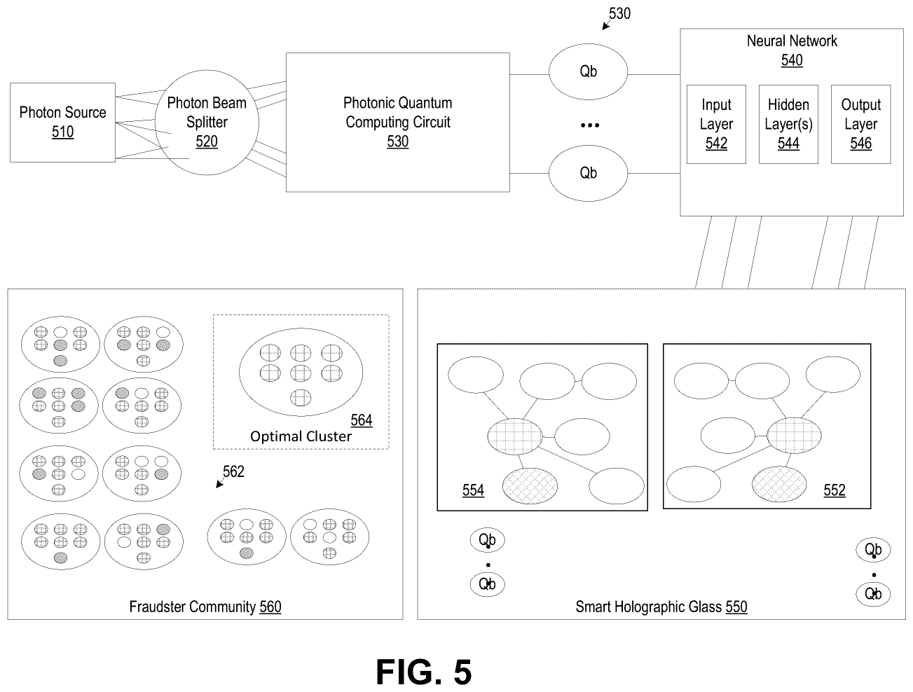

In some cases, the quantum computing system may use a photonic beam from the photon source 510 and will pass the photonic beam through a photon splitter 520 that, in turn, may be passed through the photon generator to generate qubits 530 through quantum superposition as shown in FIG. 5. The generated qubits 530 will be used to process a graphical neural network 540 that will further generate nomograms on a smart holographic glass device 550 where the users and/or user groups may be displayed via visual relationships and with connections that identify a strength of the relationship via the nomograms 552 and 554. Qubits and photonic quantum logical gates may then be used to create various user group clusters 562 using combination of various customer activities which may then be used to determine optimal cluster 564 having a high concentration or a high number of related fraudsters.

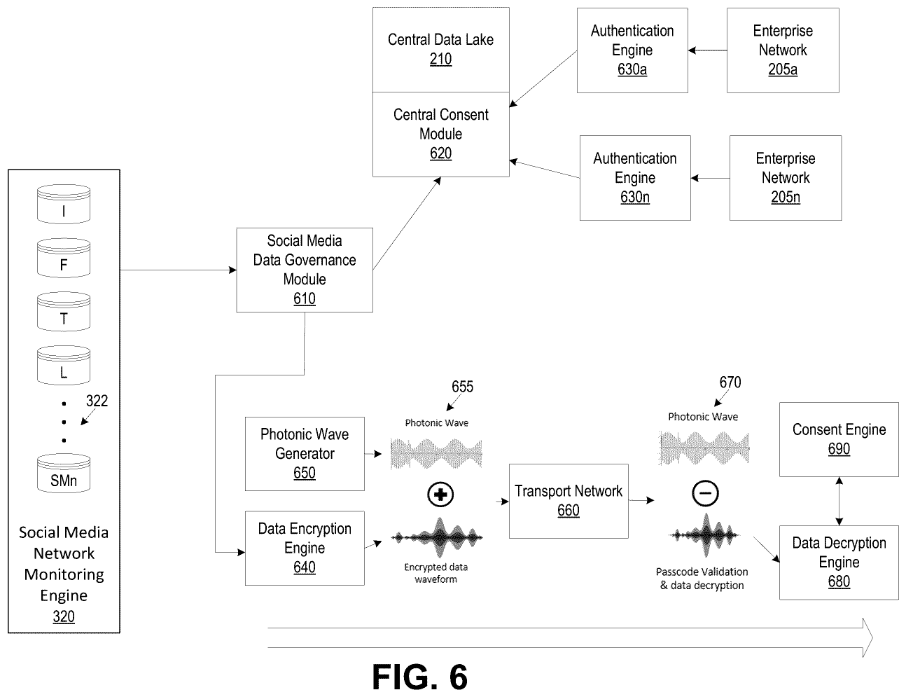

FIG. 6 shows an illustrative consent mechanism for sourcing data from social media websites using Oscillation Cryptography, according to aspects of this disclosure. To facilitate data collection from social media websites and/or organizations, a consent mechanism for sourcing user consent and or gathering data from one or more social media websites through oscillation cryptography, as shown in FIG. 6. This system may provide a two-way consent mechanism that is based on superimposition of photonic wave onto encrypted data having common passcode between social media and a consent engine of one or more financial information data store, as shown in FIGS. 2 and 3. In some cases, this method may be used to communicate consent for a first financial organization to provide encrypted data and/or read encrypted data from an enterprise network of another enterprise organization.

A social media data governance module 610 may coordinate data gathering activities from the social media networks 322, as discussed above with respect to the social media network monitoring engine 320. A photonic wave generator 650 may generate a photonic wave 655 that may further contain encrypted data generated by a data encryption engine 640. The data may include access details, media name, geographical location information, secret passcode information, and/or the like that may be stored in the enterprise organization data repository. A superimposed photonic wave may be transmitted via a transport network (e.g., a fiber optic cable, and the like) to a consent engine 690 where the consent engine 690 may first decrypt the secret passcode by the data decryption engine 680 and, if the passcode matches a known passcode, may then proceed to decrypt the encoded information and/or may perform authorization. After authentication of the social media website data, the data may then be transmitted to the central data repository via a data governance module. This data may be saved in the central repository and be made accessible to the scalable influence concentration community detection apparatus.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media a storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A system comprising:
a data repository comprising information corresponding to a plurality of electronic transactions;
an optical quantum computing device comprising:
at least one processor; and
memory storing computer-readable instructions that, when executed by the at least one processor, cause the optical quantum computing device to:
identify, based on the information corresponding to the plurality of electronic transactions, a plurality of individuals;
monitor posts associated with the plurality of individuals on a plurality of social media networks;
determine based on the plurality of posts on the plurality of social media networks, a relationship between each of the plurality of individuals;
generate, based on the relationship between each of the plurality of individuals, a relationship nomogram;
associate, based on the relationship nomogram for each of the plurality of individuals, to a group associated with a trust level; and
pause, automatically based on an identification of a new transaction, the new transaction based on a party to the new transaction being associated with a particular trust level.

2. The system of claim 1, wherein the particular trust level corresponds to one of an identification of a watchlist community assignment and a fraudster community assignment.

3. The system of claim 1, wherein each of the plurality of social media networks is monitored for posts corresponding each individual of the plurality of individuals.

4. The system of claim 1, wherein the instructions further cause the optical quantum computing device to identify a number of likes, reposts, shares, and cross-posts for each post associated with each individual of the plurality of individuals.

5. The system of claim 4, wherein the instructions further cause the optical quantum computing device to calculate, based on the number of likes, reposts, shares, and cross-posts for each post associated with each individual of the plurality of individuals, a relationship index between each individual of the plurality of individuals.

6. The system of claim 1, wherein the relationship nomogram for each individual of the plurality of individuals comprises relationships corresponding to a number of likes, reposts, shares, and cross-posts for each post associated with each individual of the plurality of individuals.

7. The system of claim 1, wherein the data repository comprises transaction information provided by a plurality of enterprise organizations.

8. A method comprising:
generating, by a photon source, a photon beam;
generating, from the photon beam, a plurality of qubits;
analyzing, by a neural network comprising the plurality of qubits, social media post information corresponding to a plurality of individuals, wherein each individual of the plurality of individuals participated in a transaction at one of a plurality of financial institutions;
generating, by the neural network, a nomogram on a smart holographic glass, wherein the nomogram shows a graphical relationship between each individual of the plurality of individuals; and
clustering, by a plurality of photonic quantum logical gates, relationships identified form the nomogram into one of a plurality of communities;
triggering, automatically, monitoring of electronic transaction records for an indication that an individual classified in a particular community cluster has participated in a new transaction; and
freeze, automatically and based on identification of the new transaction, the transaction.

9. The method of claim 8, wherein the particular community comprises a watchlist community or a fraudster community.

10. The method of claim 8, wherein the particular community comprises a fraudster community.

11. The method of claim 8, generating, by the smart holographic glass, a veracity index corresponding to each relationship between each individual of the plurality of individuals.

12. The method of claim 11, wherein the veracity index corresponds to a plurality of social media posts corresponding to each individual of the plurality of individuals.

13. The method of claim 8, further comprising:
monitoring a plurality of social media networks for posts associated with each individual of the plurality of individuals.

14. The method of claim 13, further comprising calculating, based on a number of likes, reposts, shares, and cross-posts for each post associated with each individual of the plurality of individuals, the veracity index.

15. A method comprising:
generate, by a first optical computing device, a photonic wave;
encrypt a passcode and validation information into an encrypted data waveform;
combine the encrypted data waveform with the photonic wave to form an encrypted photonic wave;
communicate the encrypted photonic wave to a second optical computing device;
decrypt, by the second optical computing device, the encrypted data waveform from the encrypted photonic wave; and
initiate monitoring of a plurality of social media networks based on data decrypted form the encrypted photonic wave.

16. The method of claim 15, further comprising:
analyzing, by a neural network comprising a plurality of qubits, social media post information corresponding to a plurality of individuals, wherein each individual of the plurality of individuals participated in a transaction at one of a plurality of financial institutions; and
generating, by the neural network, a nomogram on a smart holographic glass, wherein the nomogram shows a graphical relationship between each individual of the plurality of individuals.

17. The method of claim 16, further comprising:
clustering, by a plurality of photonic quantum logical gates, relationships identified form the nomogram into one of a plurality of communities;
triggering, automatically, monitoring of electronic transaction records for an indication that an individual classified in a particular community cluster has participated in a new transaction; and
freeze, automatically and based on identification of the new transaction, the transaction.

18. The method of claim 17, wherein the particular community comprises a fraudster community.

19. The method of claim 16, generating, by the smart holographic glass, a veracity index corresponding to each relationship between each individual of the plurality of individuals.

20. The method of claim 19, wherein the veracity index corresponds to a plurality of social media posts corresponding to each individual of the plurality of individuals.
